(19) United States
(12) Patent Application Publication
(10) Pub. No.: US 2019/0351537 A1
(43) Pub. Date: Nov. 21, 2019

(54) STAPLER

(71) Applicant: PAO SHEN ENTERPRISES CO., LTD., Chang Hua (TW)

(72) Inventors: Chun-Pin CHOU, Chang Hua (TW); Chun-Wei Chang, Chang Hua (TW)

(73) Assignee: PAO SHEN ENTERPRISES CO., LTD., Chang Hua (TW)

(21) Appl. No.: 16/123,688

(22) Filed: Sep. 6, 2018

(30) Foreign Application Priority Data
May 15, 2018 (TW) 107116400

(51) Int. Cl. B25C 5/16; B25C 5/02

(52) U.S. Cl. CPC B25C 5/1696; B25C 5/025

(57) ABSTRACT

A stapler includes an elongated channel body pivotably attached to a base, and an elongated magazine track coaxially disposed in and movable relative to a channel of the channel body in a front-and-rear direction between first and second positions. One of the channel body and the magazine track has a bottom wall on which a resilient damping member is disposed, while the other one thereof has a bottom wall which is formed with a frictionless segment, a friction-increasing segment and a stop segment. A friction end of the damping member is disposed at the frictionless segment in the first position, and is slidably moved on and frictionally engaged with the friction-increasing segment and stopped on the stop segment in the second position.

### CROSS-REFERENCE TO RELATED APPLICATION

This application claims priority of Taiwanese Patent Application No. 107116400, filed on May 15, 2018.

### FIELD

The disclosure relates to a stapler, and more particularly to a stationary stapler having a magazine track ejected from a channel body for loading staples.

### BACKGROUND

Referring to FIG. 1, a conventional stapler includes a base 11, a handle 12 pivotably connected to the base 11, a channel body 13 pivotably attached to the base 11 and downwardly of the handle 12, and a magazine track 14 adapted for storing staples thereon and coaxially disposed to and movable relative to the channel body 13. To reload or replace the staples on the magazine track 14, a push button 121 on the handle 12 is pressed for ejecting the magazine track 14 forwardly from the channel body 13 by means of a biasing action of a compression spring (not shown) interposed between the channel body 13 and the magazine track 14. However, a sudden and rapid ejection of the magazine track 14 generates an impact force that may hurt the user and others.

### SUMMARY

Therefore, an object of the disclosure is to provide a stapler that can reduce an ejection speed of a magazine track thereof.

According to the disclosure, the stapler includes a base having a base rear end, a channel body which is pivotably attached to the base rear end at a channel rear end thereof and which is elongated in a front-and-rear direction from the channel rear end to terminate at a channel front end, a magazine module and a resilient damping member. The channel body defines a channel which is bordered by a channel bottom wall that extends in the front-and-rear direction and between the channel front and rear ends. The magazine module includes a magazine track which is elongated in the front-and-rear direction and which is coaxially disposed in and movable relative to the channel in the front-and-rear direction between a first position, where a magazine front end thereof is proximate to the channel front end, and a second position, where the magazine front end is distal from the channel front end, and a magazine ejection spring which is disposed to bias the magazine track to the second position. The magazine track has a staple accommodation space and a magazine bottom wall that extends in the front-and-rear direction and borders a bottom of the staple accommodation space and that faces the channel bottom wall in an up-and-down direction. One of the channel bottom wall and the magazine bottom wall is formed with a mounting portion therein. The other one of the channel bottom wall and the magazine bottom wall is formed with a first frictionless segment which is recessed therein and which extends in the front-and-rear direction, a first friction-increasing segment which extends from and is inclined relative to the first frictionless segment in the front-and-rear direction, and a first stop segment which extends from the first friction-increasing segment in the front-and-rear direction. The resilient damping member includes a retained end which is retained in the mounting portion, and a friction end which is opposite to the retained end in the up-and-down direction, and which is disposed at the first frictionless segment when the magazine track is in the first position. The friction end is slidably moved on and frictionally engaged with the first friction-increasing segment, and is stopped on the first stop segment with an increased friction when the magazine track is moved from the first position to the second position.

### BRIEF DESCRIPTION OF THE DRAWINGS

Other features and advantages of the disclosure will become apparent in the following detailed description of the embodiments with reference to the accompanying drawings, of which:

FIG. 1 is a schematic side view of a conventional stapler;

FIG. 2 is a perspective view illustrating a first embodiment of a stapler according to the disclosure;

FIG. 3 is a partly sectioned side view of the first embodiment;

FIG. 4 is an exploded perspective view illustrating a channel body, a magazine module and a resilient damping member of the first embodiment;

FIGS. 5 to 7 are partly sectioned views illustrating a magazine track of the magazine module in first, second and pulling-out position, respectively;

FIGS. 8 and 9 are partly sectioned side views illustrating a second embodiment of a portion of the stapler according to the disclosure in states when a magazine track is in first and second positions, respectively;

FIGS. 10 and 11 are partly sectioned side views illustrating a third embodiment of a portion of the stapler according to the disclosure in states when a magazine track is in first and second positions, respectively;

FIGS. 12 to 15 are partly sectioned side views illustrating a fourth embodiment of a portion of the stapler according to the disclosure in states when a magazine track is in first, second, third and pulling-out positions, respectively; and

FIGS. 16 and 17 are partly sectioned side views illustrating a fifth embodiment of a portion of the stapler according to the disclosure in states when a magazine track is in first and pulling-out positions, respectively.

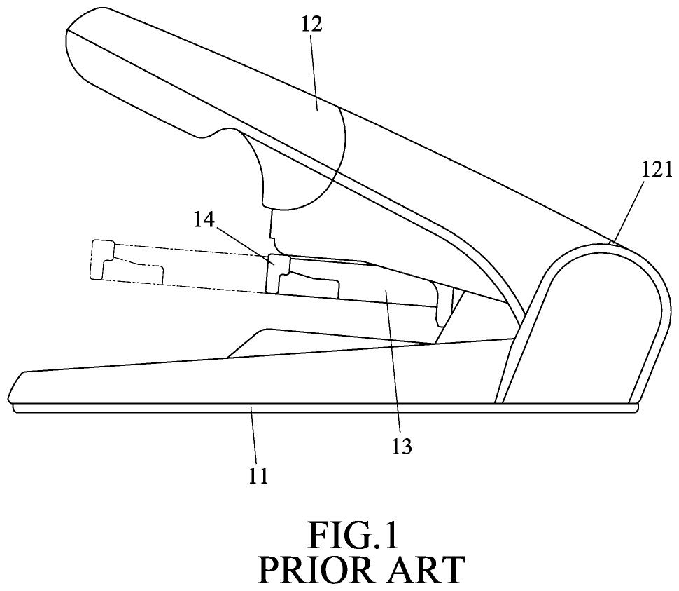

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

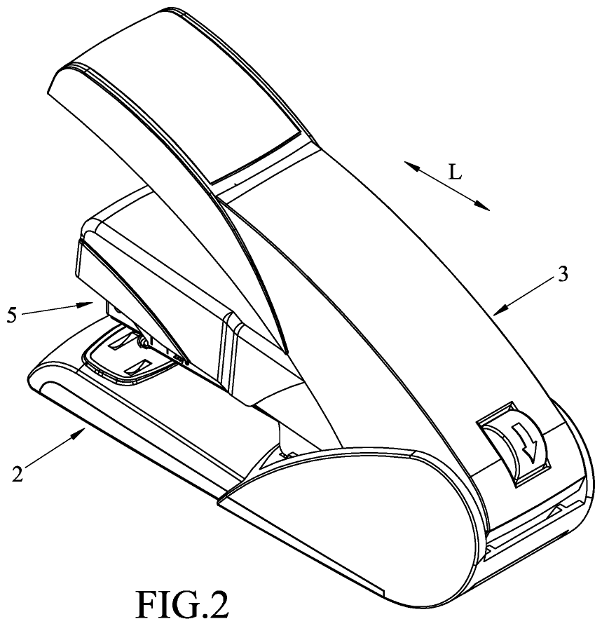

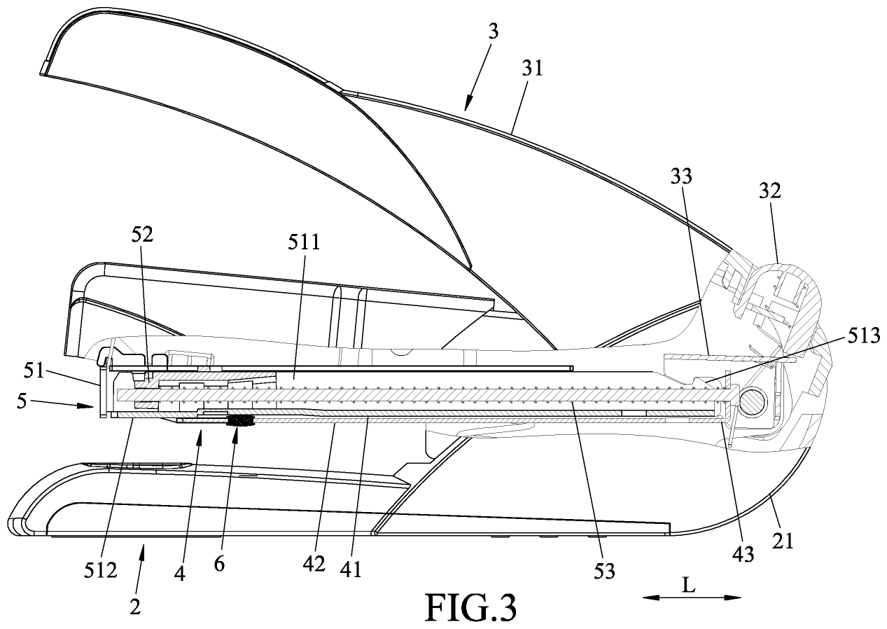

Referring to FIGS. 2 and 3, a first embodiment of a stapler according to the disclosure includes abase 2 having a base rear end 21, a handle module 3, a channel body 4, a magazine module 5 and a resilient damping member 6.

The handle module 3 includes a handle 31 having a rear end pivotably connected to the base rear end 21, a spring-biased push button 32 disposed on the handle 31, and a retaining member 33 rotated by pressing the push button 32.

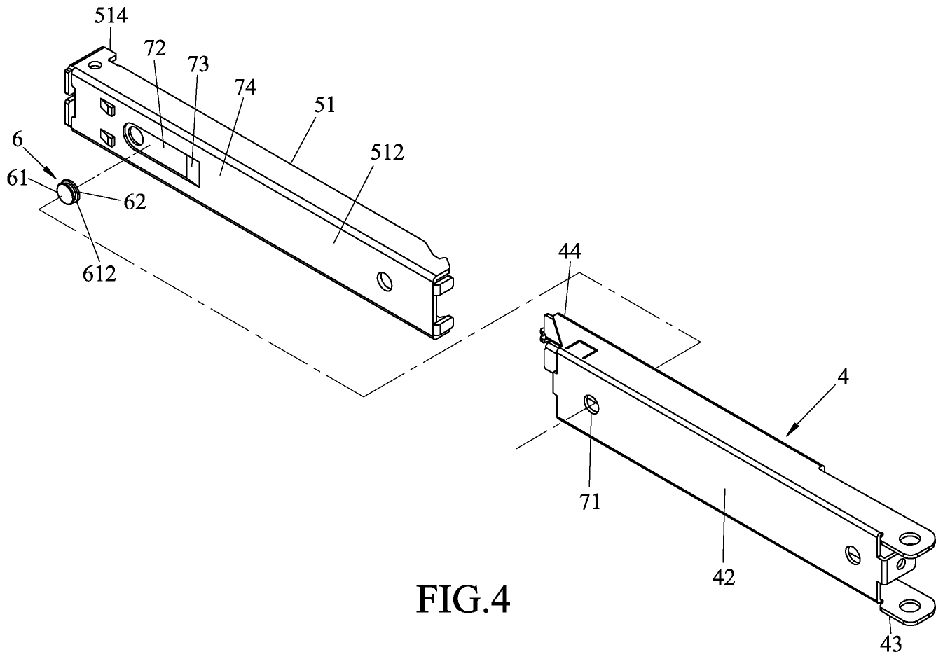

With reference to FIGS. 3 to 5, the channel body 4 is pivotably attached to the base rear end of the base 2 at a channel rear end 43 thereof, and is elongated in a front-and-rear direction (L) from the channel rear end 43 to terminate at a channel front end 44. The channel body 4 defines a channel 41 which is bordered by a channel bottom wall 42 that extends in the front-and-rear direction (L) and between the channel front and rear ends 44, 43. The channel bottom wall 42 is formed with a mounting portion 71 therein and is proximate to the channel front end 44. The mounting portion 71 is in the form of a penetrating hole.

The magazine module 5 includes a magazine track 51 which is elongated in the front-and-rear direction (L) and which is coaxially disposed in and movable relative to the channel 41, a pressing slider 52 which is disposed adjacent to a magazine front end 514 of the magazine track 51, and a magazine ejection spring 53 which is disposed to bias the magazine track 51 forwardly.

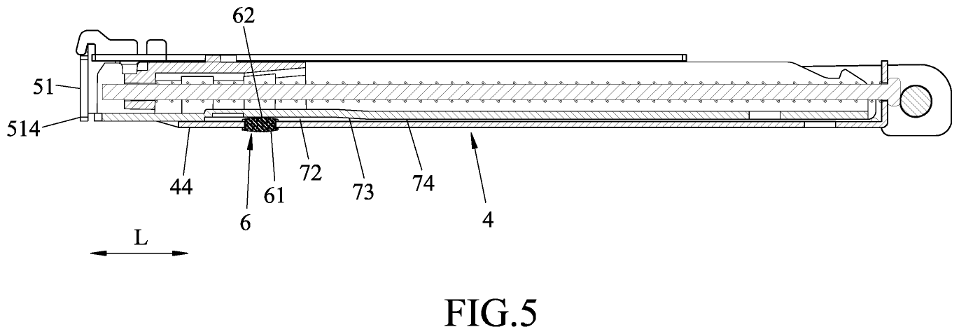

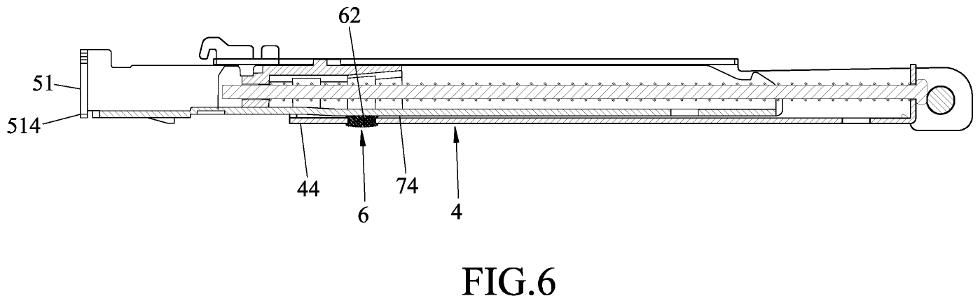

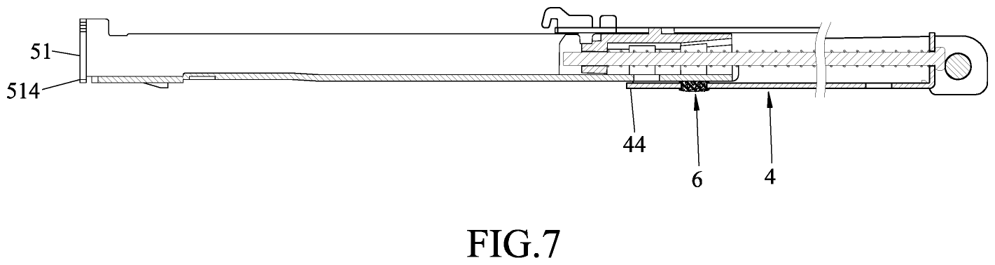

The magazine track 51 is movable relative to the channel 41 in the front-and-rear direction (L) among a first position (see FIG. 5), where the magazine front end 514 is proximate to the channel front end 44, a second position (see FIG. 6), where the magazine front end 514 is distal from and forwardly of the channel front end 44, and a pulling-out position (see FIG. 7), where the magazine front end 514 is further distal from and forwardly of the channel front end 44. The magazine track 51 has a staple accommodation space 511 for accommodating staples (not shown) therein, a magazine bottom wall 512 which extends in the front-and-rear direction (L) and borders a bottom of the staple accommodation space 511 and which faces the channel bottom wall 42 in an up-and-down direction, and an engaging member 513 which is disposed adjacent to a rear end of the magazine track 51 to be releasably engaged with the retaining member 33. By pressing the push button 32, the retaining member 33 is rotated to release the engaging member 513 therefrom so as to permit a forward movement of the magazine track 51 by means of a biasing force of the magazine ejection spring 53.

The magazine bottom wall 512 is formed with a first frictionless segment 72 which is recessed therein adjacent to the magazine front end 514 and which extends in the front-and-rear direction (L), a first friction-increasing segment 73 which extends from and is inclined relative to the first frictionless segment 72 in the front-and-rear direction (L), and a first stop segment 74 which extends from the first friction-increasing segment 73 in the front-and-rear direction (L).

The magazine ejection spring 53 is disposed between the channel rear end 43 of the channel body 4 and the pressing slider 52 to bias the magazine track 51 with the forward biasing force. In this embodiment, the magazine ejection spring 53 is a compression spring.

The resilient damping member 6 is made of resilient material, such as silicone, rubber, plastic, etc., and includes a retained end 61 which is retained in the mounting portion 71, a friction end 62 which is opposite to the retained end 61 in the up-and-down direction, and a neck portion 612 which is interposed between the retained and friction ends 61, 62 and which is dimensioned to be received in the mounting portion 71 to have the retained and friction ends 61, 62 projecting outwardly of the mounting portion 71.

With reference to FIGS. 3, 5 and 6, the friction end 62 is disposed at the first frictionless segment 72 when the magazine track 51 is in the first position, and is slidably moved on and frictionally engaged with the first friction-increasing segment 73 and stopped on the first stop segment 74 with an increased friction when the magazine track 51 is moved from the first position to the second position. In this embodiment, the friction end 62 is configured to be slightly engaged with or spaced apart from a bottom portion of the first frictionless segment 72 in the up-and-down direction to keep a friction minimized or free therebetween. Moreover, the magazine bottom wall 512 defines a central axis extending in the front-and-rear direction (L) at which the first frictionless segment 72, the first friction-increasing segment 73 and the first stop segment 74 are located. The friction end 62 is disposed to be in frictional engagement with the magazine bottom wall 512 at the central axis so as to stabilize the movement of the magazine track 51 relative to the channel body 4.

When the push button 32 is pressed to rotate the retaining member 33 to release the engaging member 513 of the magazine track 51, the magazine track 51 is ejected forwardly by means of the biasing force of the magazine ejection spring 53. During this ejection movement, the friction end 62 of the resilient damping member 6 is moved rearwardly relative to the magazine bottom wall 512 to pass over the first frictionless segment 72 without frictional engagement or with less frictional engagement with the magazine bottom wall 512. Subsequently, with an increased frictional engagement between the friction end 62 and the first friction-increasing segment 73, the ejection movement of the magazine track 51 is retarded and stopped by the first stop segment 74 so as to keep the magazine track 51 in the second position, as shown in FIG. 6. At this stage, the magazine track 51 is opened for loading staples therein. The magazine track 51 can be further moved forwardly to the pulling-out position for facilitating loading of more staples.

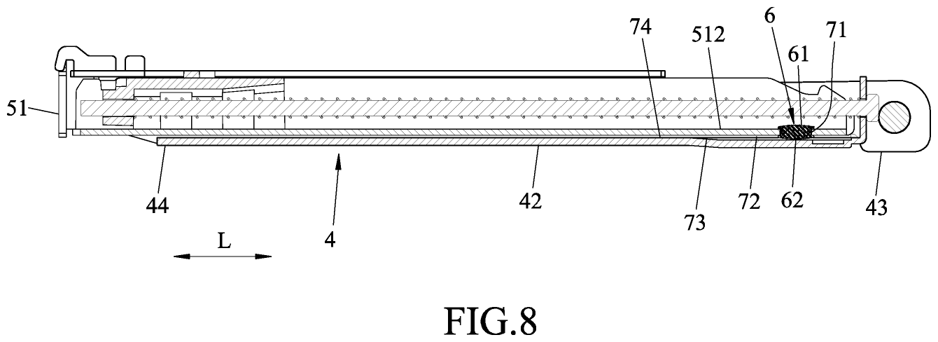

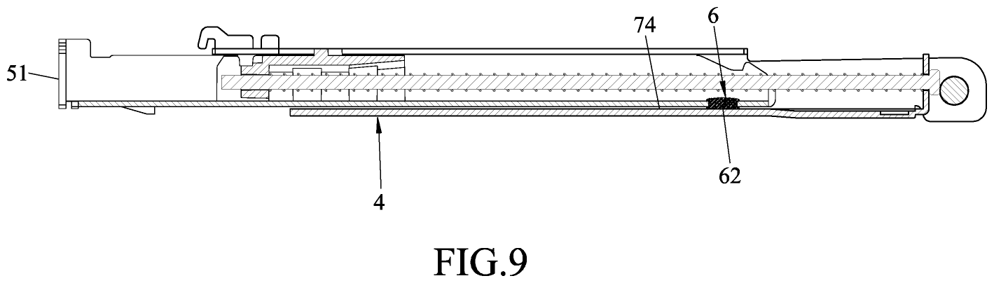

With reference to FIGS. 8 and 9, in a second embodiment, the mounting portion 71 is formed in the magazine bottom wall 512 of the magazine track 51 and is proximate to the rear end of the magazine track 51. The channel bottom wall 42 has the first frictionless segment 72, the first friction-increasing segment 73 and the first stop segment 74 which are formed proximate to the channel rear end 43 and are arranged sequentially, forwardly and in the front-and-rear direction (L). When the magazine track 51 is in the first position, as shown in FIG. 8, the friction end 62 of the resilient damping member 6 is placed in the first frictionless segment 72 for facilitating smooth sliding movement therealong. During the forward ejection movement of the magazine track 51, the friction end 62 is moved forwardly over and in frictional engagement with the first friction-increasing segment 73, and then retarded and stopped by the first stop segment 74 so as to keep the magazine track 51 in the second position.

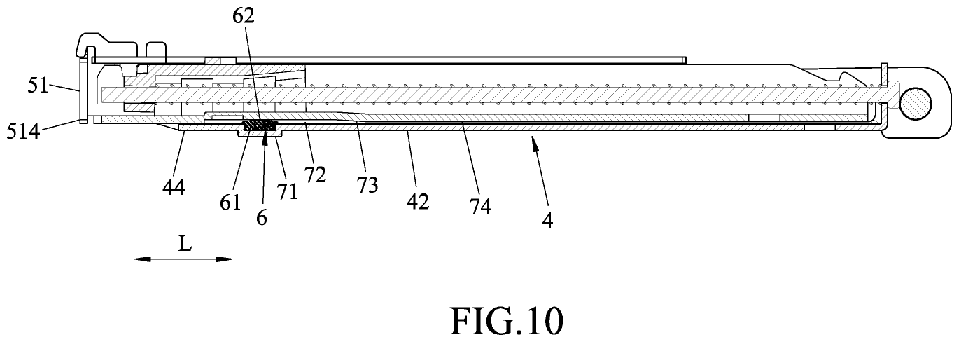

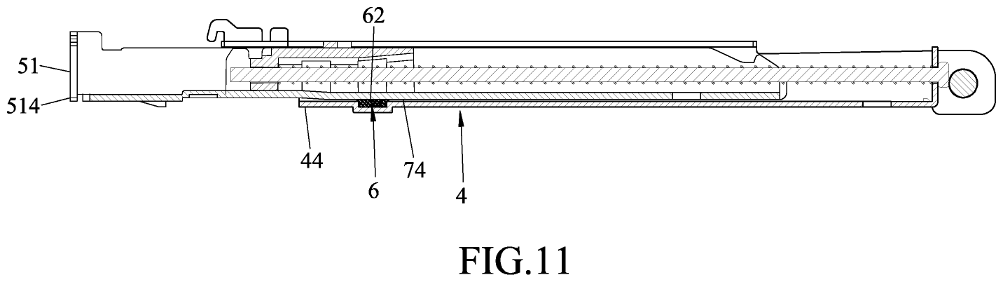

With reference to FIGS. 10 and 11, in a third embodiment, the mounting portion 71 is in the form of a bottomed hole having a closed bottom end. The resilient damping member 6 has the retained end 61 which is retained in the bottomed hole and abuts against the closed bottom end.

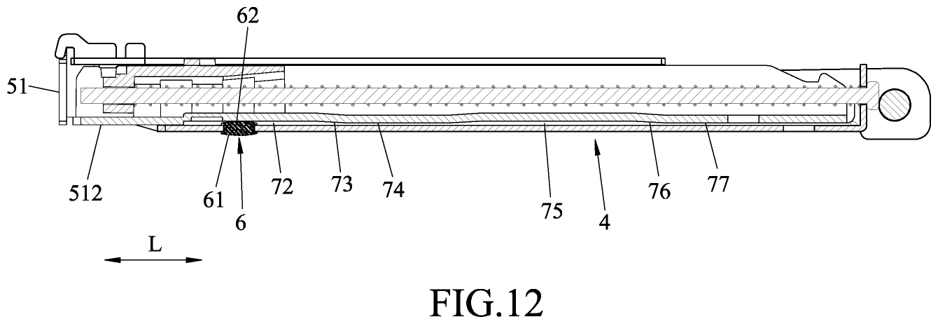

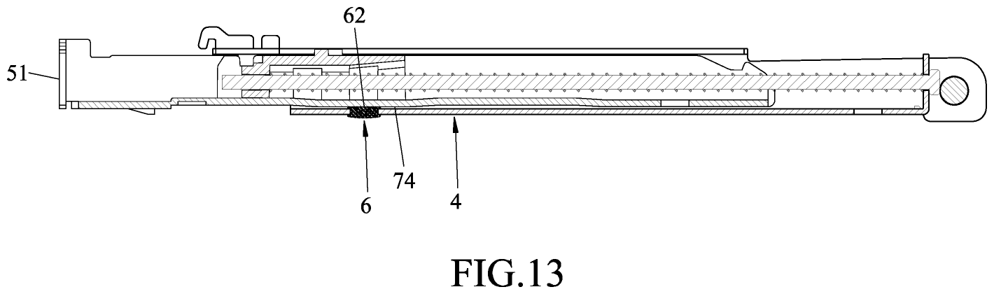

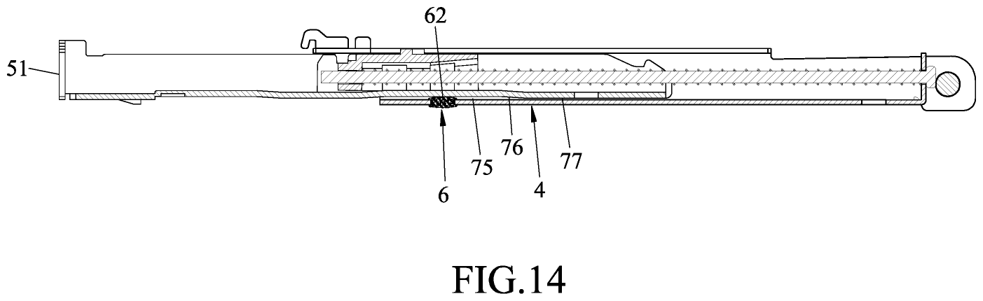

With reference to FIGS. 12 to 15, in a fourth embodiment, the magazine bottom wall 512 is further formed with a second frictionless segment 75 which extends from the first stop segment 73 rearwardly in the front-and-rear direction (L) and away from the first frictionless segment 72, a second friction-increasing segment 76 which extends rearwardly from and is inclined relative to the second frictionless segment 75 in the front-and-rear direction (L), and a second stop segment 77 which extends rearwardly from the second friction-increasing segment 76 in the front-and-rear direction (L). Similar to the first frictionless segment 72, the second frictionless segment 75 is configured to permit the friction end 62 to be slightly engaged with or spaced apart from a bottom portion thereof in the up-and-down direction to keep a friction minimized or free therebetween for permitting a further forward movement of the magazine track 51 to a third position forwardly of the second position, as shown in FIG. 14.

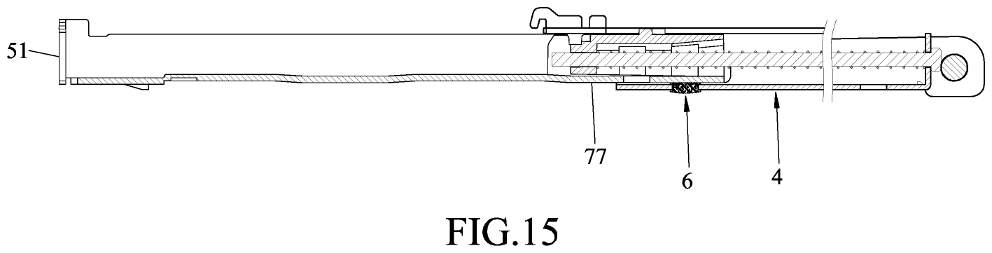

After the magazine track 51 is ejected to the second position, by pulling the magazine track 51 further forward, the friction end 62 of the resilient damping member 6 can be moved to pass over the first stop segment 74 and along the second frictionless segment 75 to the third position. Subsequently, the friction end 62 is slidably moved on and frictionally engaged with the second friction-increasing segment 76 and is stopped on the second stop segment 77 to keep the magazine track 51 in a pulling-out position, as shown in FIG. 15.

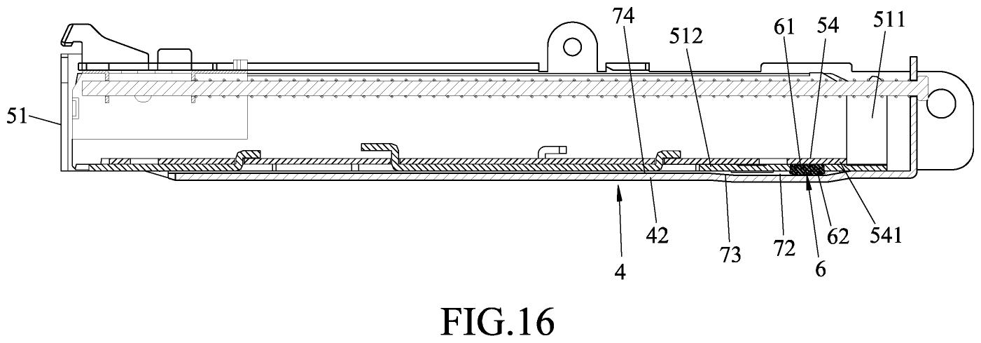

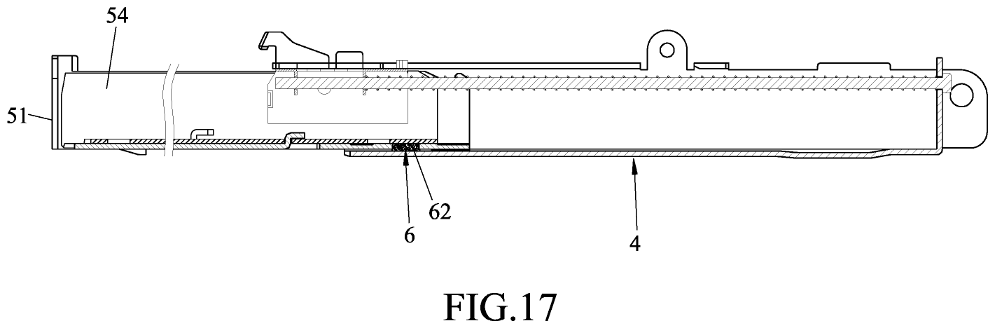

With reference to FIGS. 16 and 17, in a fifth embodiment, the mounting portion 71 is in the form of a penetrating hole formed in the magazine bottom wall 512 of the magazine track 51. The magazine module 5 further includes a staple loading guide 54 that is disposed in the staple accommodation space 511 of the magazine track 51 and that has a guide bottom wall 541 mounted on the magazine bottom wall 512. The resilient damping member 6 is dimensioned to be received in the mounting portion 71 to have the retained end 61 abutting against the guide bottom wall 541 and the friction end 62 projecting outwardly of the mounting portion 71. When the magazine track 51 is ejected forward from the first position, the guide bottom wall 541 is moved therewith, and the friction end 62 of the resilient damping member 6 is moved forwardly over and in frictional engagement with the first friction-increasing segment 73 and then retarded and stopped by the first stop segment 74 to the second position. The magazine track 51 can be further moved forwardly to the pulling-out position, as shown in FIG. 17, for facilitating loading of staples in the staple loading guide 54.

As illustrated, with the resilient damping member 6 disposed in the mounting portion 71 on one of the channel bottom wall 42 and the magazine bottom wall 512, and the first frictionless segment, 72, a first friction-increasing segment 73 and the first stop segment 74 disposed on the other one of the channel bottom wall 42 and the magazine bottom wall 512, the ejection movement of the magazine track 51 can be smooth, retarded and then stopped for safety purposes. With the first frictionless segment 72 configured not to be frictionally engaged with the friction end 62, the ejection movement of the magazine track 51 is smooth and successful from the first position. With the friction end 62 disposed corresponding with the central axis of the magazine bottom wall 512, the frictional force is applied to the magazine bottom wall 512 along the central axis so as to stabilize the ejection movement of the magazine track 51. Specifically, with the second frictionless segment 75 configured to keep a friction minimized or free to the friction end 62, a further forward movement of the magazine track 51 by pulling out is convenient and successful. Furthermore, with addition of the second friction-increasing segment 76 and the second stop segment 77, the pulling-out movement of the magazine track 51 can be retarded and stopped. With the mounting portion 71 in the form of a penetrating hole, the resilient damping member 6 is easy to be disposed therein and retained by the retained and friction ends 61, 62 projecting outwardly of the penetrating hole. Specifically, with the staple loading guide 54 abutting against the retained end 61 of the resilient damping member 6, undesired movement of the resilient damping member 6 in the magazine track 51 during the ejection movement of the magazine track 51 is prevented.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A stapler comprising:
a base having a base rear end;
a channel body which is pivotably attached to said base rear end at a channel rear end thereof and which is elongated in a front-and-rear direction from said channel rear end to terminate at a channel front end, said channel body defining a channel which is bordered by a channel bottom wall that extends in the front-and-rear direction and between said channel front and rear ends;
a magazine module including a magazine track which is elongated in the front-and-rear direction and which is coaxially disposed in and movable relative to said channel in the front-and-rear direction between a first position, where a magazine front end thereof is proximate to said channel front end, and a second position, where said magazine front end is distal from said channel front end, and a magazine ejection spring which is disposed to bias said magazine track to the second position, said magazine track having a staple accommodation space and a magazine bottom wall that extends in the front-and-rear direction and borders a bottom of said staple accommodation space and that faces said channel bottom wall in an up-and-down direction, one of said channel bottom wall and said magazine bottom wall being formed with a mounting portion therein, the other one of said channel bottom wall and said magazine bottom wall being formed with a first frictionless segment which is recessed therein and which extends in the front-and-rear direction, a first friction-increasing segment which extends from and is inclined relative to said first frictionless segment in the front-and-rear direction, and a first stop segment which extends from said first friction-increasing segment in the front-and-rear direction; and
a resilient damping member including a retained end which is retained in said mounting portion, and a friction end which is opposite to said retained end in the up-and-down direction, and which is disposed at said first frictionless segment when said magazine track is in the first position, said friction end being slidably moved on and frictionally engaged with said first friction-increasing segment and stopped on said first stop segment with an increased friction when said magazine track is moved from the first position to the second position.

2. The stapler as claimed in claim 1, wherein said first frictionless segment is configured to have a bottom portion that is spaced apart from said friction end of said resilient damping member in the up-and-down direction to keep a frictionless therebetween.

3. The stapler as claimed in claim 1, wherein said mounting portion is formed in said channel bottom wall and proximate to said channel front end, said magazine bottom wall having said first frictionless segment, said first friction-increasing segment and said first stop segment which are formed proximate to said magazine front end and are arranged sequentially in the front-and-rear direction.

4. The stapler as claimed in claim 1, wherein said mounting portion is formed in said magazine bottom wall and proximate to a rear end of said magazine track, said channel bottom wall having said first frictionless segment, said first friction-increasing segment and said first stop segment which are formed proximate to said channel rear end and are arranged sequentially in the front-and-rear direction.

5. The stapler as claimed in claim 1, wherein said magazine bottom wall defines a central axis extending in the front-and-rear direction, said friction end being disposed to be in frictional engagement with said magazine bottom wall at the central axis so as to stabilize the movement of said magazine track between the first and second position.

6. The stapler as claimed in claim 1, wherein said mounting portion is in form of either one of a bottomed hole and a penetrating hole.

7. The stapler as claimed in claim 1, wherein said other one of said channel bottom wall and said magazine bottom wall is formed with a second frictionless segment which extends from said first stop segment in the front-and-rear direction and away from said first frictionless segment and which is configured for permitting a further forward movement of said magazine track to a third position forwardly of the second position.

8. The stapler as claimed in claim 1, wherein said other one of said channel bottom wall and said magazine bottom wall is formed with a second frictionless segment which extends from said first stop segment in the front-and-rear direction and away from said first frictionless segment and which is configured for permitting a further movement of said magazine track to a third position forwardly of the second position, a second friction-increasing segment which extends from and is inclined relative to said second frictionless segment in the front-and-rear direction, and a second stop segment which extends from said second friction-increasing segment in the front-and-rear direction such that said friction end is slidably moved on and frictionally engaged with said second friction-increasing segment and stopped on said second stop segment when said magazine track is moved forwardly from the third position to a pulling-out position.

9. The stapler as claimed in claim 1, wherein said mounting portion is in form of a penetrating hole, said resilient damping member having a neck portion which is interposed between said retained and friction ends and which is dimensioned to be received in said penetrating hole to have said retained and friction ends projecting outwardly of said penetrating hole.

10. The stapler as claimed in claim 1, wherein said mounting portion is in form of a penetrating hole, said magazine module including a staple loading guide which is disposed in said staple accommodation space of said magazine track and which has a guide bottom wall mounted on said magazine bottom wall, said resilient damping member being dimensioned to be received in said penetrating hole to have said retained end abutting against said guide bottom wall and said friction end projecting outwardly of said penetrating hole.
